(19) United States
(12) Patent Application Publication
(10) Pub. No.: US 2003/0133226 A1
(43) Pub. Date: Jul. 17, 2003

(54) FPC design and HGA assembly process

(76) Inventor: Ping Shang, Dongguan City (CN)

Correspondence Address: KENYON & KENYON, Suite 600, 333 W. San Carlos, Street, San Jose, CA, 95110-2711, US

(21) Appl. No.: 10/104,386

(22) Filed: Mar. 21, 2002

(30) Foreign Application Priority Data
Jan. 17, 2002 (WO) PCT/CN02/00021

(51) Int. Cl. G11B 5/60

(52) U.S. Cl. 360/234.5

(57) ABSTRACT

The present invention relates to a reverse type of HGA and an HGA assembling process for producing the reverse type of HGA. The reverse type of HGA comprises a slider 40, some traces 31 with related bound pads 32 on an FPC 30 used as signal lines, and some bump pads 41 on said slider 40 used as slider MR element terminals; wherein the bonding area of the slider 40 of the reverse type of HGA is provided on opposite side of the flexure to that of the conventional HGA. The HGA assembling process comprises steps: forming a reverse type of FPC 30; mounting a slider 40 to a FPC sheet 300 by epoxy, bound pads being in alignment with bump pads; finishing slider bounding by an SBB machine; cutting the FPC 30 with the slider 40 from the FPC sheet 300; and mounting the FPC 30 with slider 40 to suspension 10 by epoxy.

### TECHNICAL FIELD OF THE INVENTION

The present invention generally relates to a new type of FPC (flex print cable) design and its process used in the magnetic head assembly process of HGA production for hard disk drives, and more specifically, to a reverse type of HGA using the new type of FPC design and a process for manufacturing this reverse type of HGA.

### BACKGROUND OF THE INVENTION

In a conventional head gimbal assembly, a thin film magnetic head (slider) is mechanically attached to a suspension flexure by epoxy bonding. A thin film magnetic head transducer is electrically connected to read/write electronic by printed traces which run the length of the suspension. One end of these traces is ultrasonically bonded to gold plated transducer termination pads on the slider.

U.S. Pat. No. 4,996,623 discloses an integrated suspension fabricated by etching a copper alloy/polyimide/stainless steel laminate, the twisted pairs of wires have been replaced by a copper alloy lead structure. The electrical conductors that deliver information to and from the magnetic head are incorporated into a layer of the suspension. A method for producing had gimbal assemblies using integrated suspensions id disclosed, for example in U.S. Pat. No. 4,761,699.

U.S. Pat. No. 5,828,031 entitled “Head Transducer to Suspension Lead Termination by Solder Ball Place/Reflow”, issued to Pattanaik Surya on Oct. 27, 1998 discloses a method for forming electrical solder connections between a thin film magnetic head transducer and the conductors in an integrated suspension after the head has been mechanically attached to a suspension. A solder ball is placed between the head and conductor termination pads. A focused laser beam is used to produce solder reflow. The resulting solder connection has a fine grain structure and includes a pair of thin layers of intermetallic compounds in the regions where the solder connection abuts the head and conductor termination pads. However, the process is more complicated, and the process cost is higher.

Use of a flex cable on a suspension type of HGA 100 (called FSA (flex cable suspension assembly) design) is one of the conventional HGA designs, as shown in FIG. 1.0, which HGA comprises a suspension 10, a flexure 20, a FPC 30 (or flex cable) and a slider 40.

Some traces 31 used as signal lines with corresponding bound pads 32 are provided on FPC 30, and some bump pads 41 used as slider MR element terminals are provided on the slider 40, as shown in FIG. 1.1 and FIG. 1.2.

The conventional FSA process usually comprising steps:

a) cutting an FPC 30 from an FPC sheet;

b) mounting the FPC 30 to a suspension 10 by epoxy;

c) mounting a slider 40 to the FPC 30 on the suspension 10; and

d) connecting slider pads 41 to corresponding FPC pads 32, respectively, by a GBB (gold ball bounding) or SBB (solder ball bounding) process.

As shown in FIG. 3.1, there is an SBB machine comprising a laser head with a focus system, a monitor with a camera positioning system and a flex cable sheet station with a conveyer system. The laser head can be controlled from the monitor to move vertically and horizontally by the camera positioning system, and the conveyer belt of the transport system can be controlled to move step by step.

An SBB bonding method for an HGA by means of an SBB machine comprises steps:

a) making a flex cable trace pattern onto a flex cable sheet by etching or the like;

b) mounting sliders onto the flex cable sheet by epoxy, with precise alignment to trace pads one by one;

c) connecting a slider's pad to the corresponding pads of the flex cable trace by SBB or the like;

d) cutting the flex cable provided with the sliders from the flex cable sheet;

e) mounting the flex cable provided with the sliders onto a suspension by epoxy or the like, and finishing an HGA.

The present invention intends to achieve developments in use of the SBB machine and method

### SUMMARY OF THE INVENTION

As far as dynamics and functions of an HGA are concerned, some customers hope to get a reverse type of HGA structure, as shown in FIGS. 2.1 and 2.2, where the slider bounding area is provided on the opposite side of the flexure to that of the conventional flexure.

However, it is very difficult for the conventional assembly process to manufacture this reverse type of HGA.

Therefore, an object of the invention is to provide a reverse type of HGA by means of a new type FPC design.

A further object of the invention is to provide a process for manufacturing this reverse type of HGA.

In an aspect of the present invention, a reverse type of HGA comprises a suspension, a flexure, a modified FPC (or flex cable) and a slider, some traces with related bound pads on an FPC used as signal lines, and some bump pads on said slider used as slider MR element terminals;

wherein the bonding area of the slider of the reverse type of HGA is provided on the opposite side of the flexure to that of the conventional HGA.

In a further aspect of the present invention, an HGA assembling process for producing a reverse type of HGA comprising steps:

1) forming a reverse type of FPC;

2) mounting a slider to a FPC sheet by epoxy, bound pads being in alignment with bump pads;

3) finishing slider bounding by an SBB machine;

4) cutting the FPC with the slider from the FPC sheet; and

5) mounting the FPC with the slider to suspension by epoxy

Since the process of the present invention is performed by changing slider bounding from the suspension level to the FPC level, the problem of damage of a suspension by clamps and that of suspension pitch/roll change by heating are eliminated automatically.

It is very easy for an SBB process to design a fixture and machine to manufacture such a kind of slider bounding on an FPC and easy for mass production, with no damage to the suspension.

### BRIEF DESCRIPTION OF THE DRAWINGS

The objects and features of the present invention will become more apparent from consideration of the following detailed description taken in conjunction with the accompanying drawings, in which like reference numerals designate like elements, and in which:

FIG. 1.0 shows a conventional FSA type of HGA configuration;

FIG. 1.1 shows the detail drawing for slider area of FIG. 1.0;

FIG. 1.2 shows the side view of the HGA in FIG. 1.0;

FIG. 2.1 shows the details of the slider area of a reverse type of HGA;

FIG. 2.2 shows the side view of the reverse type HGA;

FIG. 3.1 shows the perspective diagram an SBB machine used by the present invention;

FIG. 3.2 shows the process drawing of the slider mounting on FPC sheet;

FIG. 3.3 shows the process drawing of FPC cutting; and

FIG. 3.4 shows the process drawing of an FSA type of HGA assembly.

### DESCRIPTION OF PREFERRED EMBODIMENTS OF THE INVENTION

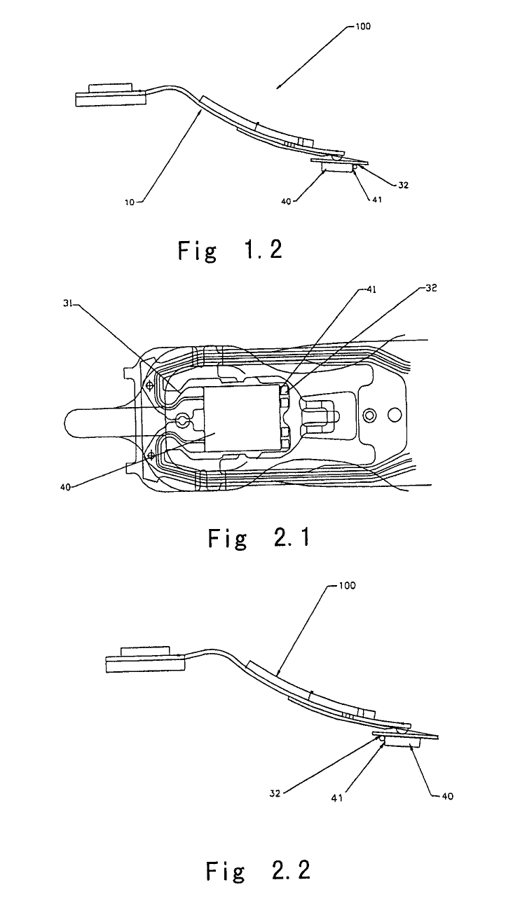

Firstly, refer to FIG. 2.1 which shows the details of the slider area of a reverse type of HGA in accordance with the present invention. The HGA comprises a suspension 10, a flexure 20, a modified FPC 30 (or flex cable) and a slider 40. Some traces 31 with associated bound pads 32 on the FPC 30 are used as signal lines, and some bump pads 41 on the slider 40 used as slider MR element terminals, as shown in FIGS. 2.1 and 2.2.

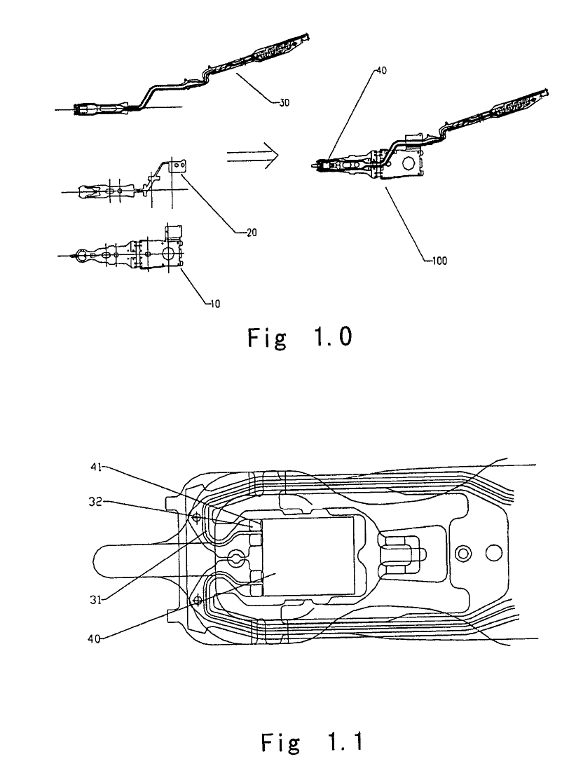

In comparison of the reverse type of HGA shown in FIGS. 2.1 and 2.2 to the conventional HGA shown in FIGS. 1.1 and 1.2, the bonding area of the slider 40 of the reverse type of HGA is provided on the opposite side of the flexure to that of the conventional HGA. With the exception of this, other details of the reverse type of HGA are identical to those of the conventional HGA, and further description of the reverse type of HGA of the present invention is omitted. Nevertheless, bonding a head of the reverse type of HGA by a conventional method is so difficult that it will touch, or even damage the suspension.

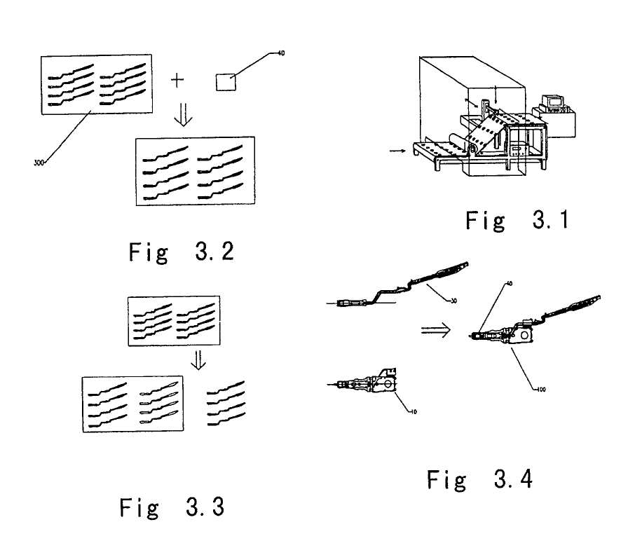

FIG. 3.1 shows the perspective diagram an SBB machine used by the present invention.

Now turn to FIGS. 3.2-3.4, an HGA assembling process in accordance with the present invention comprises steps:

1) forming a reverse type of FPC 30 as shown in FIG. 2.1;

2) mounting a slider 40 to a FPC sheet 300 by epoxy, bound pads 32 being in alignment with bump pads 41, as shown in FIG. 3.2;

3) finishing slider bounding by an SBB machine, as shown in FIG. 3.1;

4) cutting the FPC 30 with the slider 40 from the FPC sheet 300, as shown in FIG. 3.3; and

5) mounting the FPC 30 with slider 40 to suspension 10 by epoxy, as shown in FIG. 3.4.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A reverse type of HGA comprises a suspension 10, a flexure 20, a modified FPC (or flex cable) (30) and a slider (40), some traces (31) with related bound pads (32) on an FPC (30) used as signal lines, and some bump pads (41) on said slider (40) used as slider MR element terminals;
wherein the bonding area of the slider (40) of the reverse type of HGA is provided on the opposite side of the flexure to that of the conventional HGA.

2. An HGA assembling process for producing a reverse type of HGA comprising steps:
1) forming a reverse type of FPC (30);
2) mounting a slider (40) to a FPC sheet (300) by epoxy, bound pads being in alignment with bump pads;
3) finishing slider bounding by an SBB machine;
4) cutting the FPC (30) with the slider (40) from the FPC sheet (300); and
5) mounting the FPC (30) with slider (40) to suspension (10) by epoxy.
